(19) United States
(12) Patent Application Publication
(10) Pub. No.: US 2026/0317178 A1
(43) Pub. Date: Oct. 15, 2026

(54) Molten Salt Synthesis of Uranium Carbide

(71) Applicant: Oregon State University, Corvallis, OR (US)

(72) Inventors: Devin Gray McGlamery, Corvallis, OR (US); Alexander Theodore Chemey, Corvallis, OR (US); Victoria Lee Augustine, Corvallis, OR (US)

(73) Assignee: Oregon State University, Corvallis, OR (US)

(21) Appl. No.: 19/647,192

(22) Filed: Apr. 14, 2026

Related U.S. Application Data
(60) Provisional application No. 63/788,922, filed on Apr. 15, 2025.
(60) Provisional application No. 63/941,801, filed on Dec. 16, 2025.

(51) Int. Cl. C01B 32/928

(52) U.S. Cl. CPC C01B 32/928; C01P 2002/72; C01P 2004/03

(57) ABSTRACT

A method for producing uranium carbide, the method including: heating a vessel containing a blend including a uranium source, a chloride salt, a carbon source, and a reductant under a non-participating cover gas, wherein the vessel is maintained at a reaction temperature and for a reaction time sufficient to produce a molten reaction mixture including the uranium carbide; and isolating the uranium carbide, wherein the uranium source is a uranium oxide or a uranium halide. A system for producing uranium carbide, the system including: a vessel containing a uranium-containing blend and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium carbide.

### CROSS REFERENCE TO RELATED APPLICATIONS

This application claims priority to Provisional Application No. 63/788,922 filed Apr. 15, 2025, and Provisional Application No. 63/941,801 filed Dec. 16, 2025, the entire disclosures of which are hereby incorporated by reference in their entireties.

### STATEMENT OF GOVERNMENT LICENSE RIGHTS

This invention was made with government support under Award No. DE-NE0009394 awarded by the US Department of Energy. The government has certain rights in the invention.

### BACKGROUND

Uranium monocarbide (UC) and uranium dicarbide (UC₂) (collectively, “uranium carbide”) are useful materials in the production of advanced nuclear fuels.

State of the art industrial scale uranium carbide, such as uranium monocarbide, is currently synthesized through carbothermal reduction at temperatures in excess of 1500° C. for multiple days under vacuum. This process is energy intensive and inefficient due to the prolonged reaction times at such elevated temperatures. Furthermore, the process is prone to the loss of carbon from the system, limiting isotopic enrichment when this is desirable.

A need exists for a system and method for producing high purity uranium carbide with reduced synthetic and processing costs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, the present disclosure provides a method for producing uranium carbide (“UC”), the method including: heating a vessel containing a blend including a uranium source, a chloride salt, a carbon source, and a reductant under a non-participating cover gas, wherein the vessel is maintained at a reaction temperature and for a reaction time sufficient to produce a molten reaction mixture including the uranium carbide; and isolating the uranium carbide, wherein the uranium source is a uranium oxide or a uranium halide.

In some embodiments, the uranium oxide is selected from the group consisting of UO₂, UO₃, and UOₓ, where 1.9≤x≤3.

In some embodiments, the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UI₆, and combinations thereof.

In some embodiments, the uranium halide includes a mixed metal uranium halide.

In some embodiments, the chloride salt is LiCl, NaCl, KCl, CaCl₂, or GaCl₃.

In some embodiments, the chloride salt includes a first chloride salt and a second chloride salt having a binary ratio of the first chloride salt and the second chloride salt, wherein the binary ratio is about a eutectic ratio.

In some embodiments, the reductant is an alkali metal, an alkaline earth metal, an alkali metal hydride, or an alkaline earth metal hydride.

In some embodiments, the reductant is selected from the group consisting of Li, Na, K, Rb, Mg, Ca, Sr, LiH, NaH, KH, RbH, MgH₂, CaH₂, and SrH₂.

In some embodiments, the non-participating cover gas is nitrogen, a noble gas, or CO₂.

In some embodiments, the vessel is a zirconia vessel, a nickel vessel, a tungsten vessel, a tantalum vessel, a stainless-steel vessel, or a molybdenum vessel.

In some embodiments, the vessel is configured to produce uranium carbide in a batch process.

In some embodiments, the vessel is configured to produce uranium carbide in a flow process.

In some embodiments, the reaction temperature is between about 200° C. and 900° C.

In some embodiments, the reaction temperature is between about 600° C. and 900° C.

In some embodiments, the reaction time is less than 24 hours, less than 10 hours, less than 8 hours, less than 6 hours, less than 4 hours, less than 2 hours, or less than 1 hour.

In some embodiments, the method further includes cooling the molten reaction mixture to a temperature below the melting point of the chloride salt to provide the uranium carbide and a salt byproduct.

In some embodiments, further includes rinsing the cooled molten reaction mixture with a polar aprotic solvent.

In some embodiments, the polar aprotic solvent is tetrahydrofuran (THF), dimethylformamide (DMF), or dimethyl sulfoxide (DMSO).

In some embodiments, cooling the molten reaction mixture includes cooling at a cooling rate.

In some embodiments, the cooling rate is between about 0.1° C./min to about 10° C./min.

In some embodiments, a stoichiometric ratio of the blend is 1 mole uranium oxide:between about 1.2 to about 100 moles chloride salt:between about 1 to about 4 moles carbon source:between about 1 to about 20 moles of reductant.

In some embodiments, isolating the reaction includes hot filtering the reaction mixture, thereby providing the uranium carbide.

In an aspect, the present disclosure provides a composition including the uranium carbide produced by the methods described herein.

In an aspect, the present disclosure provides a method for producing uranium carbide, the method including: heating a zirconia, a tantalum, or a nickel crucible containing a blend including a uranium source, LiCl, a carbon source, and LiH or CaH₂ under argon or nitrogen gas, wherein the zirconia, tantalum, or nickel crucible is maintained at a reaction temperature of between about 600° C. and about 900° C. for 8 hours thereby providing uranium carbide; and isolating the uranium carbide, wherein the uranium source is a uranium oxide or a uranium halide.

In an aspect, the present disclosure provides a system for producing uranium carbide, the system including: a vessel including a uranium-containing blend for forming a uranium carbide and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium carbide produced by the reaction of the uranium-containing blend.

In some embodiments, the vessel is a zirconia vessel, a nickel vessel, a tungsten vessel, a tantalum vessel, a stainless-steel vessel, or a molybdenum vessel.

In some embodiments, the uranium-containing blend includes a uranium source, a chloride salt, a carbon source incorporated into the uranium-containing blend, and a reductant, wherein the uranium source is a uranium oxide or a uranium halide.

In some embodiments, the heating element is further configured to cool the vessel to a temperature below the melting point of the chloride salt.

In some embodiments, the reaction temperature is between about 200° C. and 900° C.

In some embodiments, the processing zone is a batch processing zone configured to isolate uranium carbide in a batch process.

In some embodiments, the processing zone is a flow processing zone configured to continuously isolate uranium carbide in a flow process.

In some embodiments, the carbon source is solid black carbon.

In some embodiments, the uranium-containing blend comprises a reductant and a chloride salt.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 depicts a system for producing uranium carbide, according to embodiments of the present disclosure;

FIG. 2 depicts a process for producing uranium carbide, according to embodiments of the present disclosure;

FIG. 3 depicts powder XRD patterns of UC from UCl₄, UBr₅, UO₂ or UO₃ synthesized by the molten salt method after isolation using DMF, according to embodiments of the present disclosure;

FIG. 4A depicts SEM of UC derived from UO₂, according to embodiments of the present disclosure;

FIG. 4B depicts SEM of UC derived from UO₃, according to embodiments of the present disclosure;

FIG. 4C depicts SEM of UC derived from UCl₄, according to embodiments of the present disclosure;

FIG. 4D depicts SEM of UC derived from UBr₅, according to embodiments of the present disclosure;

FIG. 5 depicts powder XRD patterns of UO₂ and UO₃ derived UC synthesized by the molten salt method using CaH₂ as a reductant, according to embodiments of the present disclosure; and

FIG. 6 depicts powder XRD patterns of UBr₅ derived UC/UC₂ synthesized by the molten salt method, according to embodiments of the present disclosure.

### DETAILED DESCRIPTION

The present disclosure addresses these needs for a system and method for producing high purity uranium carbide with reduced synthetic and processing costs and related needs by providing systems and methods for producing uranium carbide. An advantage of the present disclosed systems and methods is the reduced reaction time, reduced energy costs, and improved carbon retention relative to existing systems and methods.

### Systems for Producing Uranium Carbide

In an aspect, the present disclosure provides a system for producing uranium carbide, the system including: a vessel including a uranium-containing blend for forming a uranium carbide and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium carbide produced by the reaction of the uranium-containing blend.

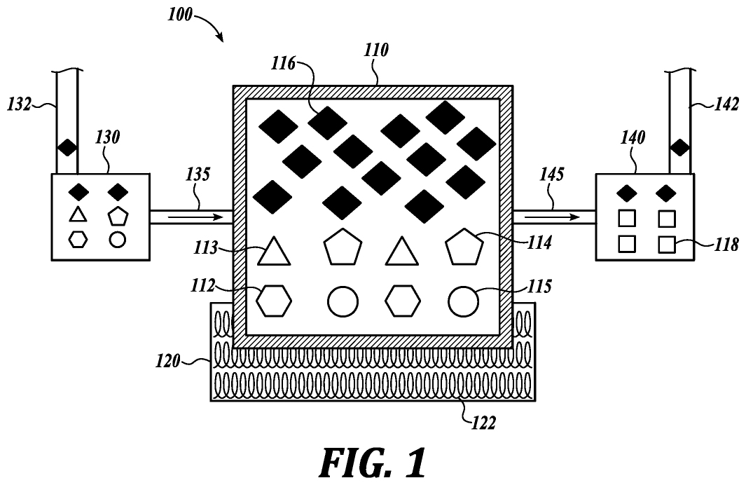

In this regard, FIG. 1 provides a schematic illustration of a system 100 for producing uranium carbide. It should be understood that system 100 is provided as an example of a system capable of carrying out the methods described in the present disclosure, and that other configurations of the various elements of system 100 may be used. Moreover, not every element illustrated in system 100 may be required to perform the methods described herein, and that additional elements may be incorporated into system 100 within the achievement of one having ordinary skill in the art. In this regard, it should be understood that certain embodiments of the systems described herein may be described in relation to various method steps, and certain embodiments of the methods described herein may be described in relation to various system elements.

System 100 includes a vessel 110 which includes within it a uranium-containing blend. In some embodiments, the uranium-containing blend includes uranium source 112, chloride salt 113, carbon source 114, and reductant 115. Vessel 110 further includes a non-participating cover gas 116. In some embodiments, carbon source 114 is a solid black carbon.

Vessel 110 contacts heating element 120 with heating coils 122. Vessel 110 may, in some embodiments, be coupled to input source 130 (such as for providing additional uranium source 112, chloride salt 113, carbon source 114, reductant 115, and/or non-participating cover gas 116) via input coupling 135. Similarly, vessel 110 may, in some embodiments, be coupled to processing zone 140 via coupling 145. Processing zone 140 may be an integrated component of vessel 110, or may be an external region for processing of product from vessel 110.

Input source 130 may include cover gas supply 132 for introducing non-participating cover gas 116 into the input source 130. For instance, in a flow process, non-participating cover gas 116 is introduced into input source 130, which then enters the vessel 110 via input coupling 135 with the uranium source 112, chloride salt 113, carbon source 114, and reductant 115. An advantage of this embodiment is that reactive gases may be purged from the system prior to heating to prevent contamination. However, it should be understood that other methods of introducing non-participating cover gas 116 are within the scope of this disclosure, such as where non-participating cover gas 116 is introduced directly into vessel 116.

Similarly, in a flow process, uranium source 112, chloride salt 113, carbon source 114, and reductant 115 may be introduced continuously to vessel 110, such as by using a conveyor to continuously transfer uranium source 112, chloride salt 113, carbon source 114, and reductant 115 into the vessel 110.

Conversely, in a batch process, uranium source 112, chloride salt 113, carbon source 114, reductant 115, and non-participating cover gas 116 may be introduced in a process step before the vessel 110 is heated. This would permit purging of contaminant gases from the system prior to the heating process being initiated.

Uranium source 112, chloride salt 113, carbon source 114, reductant 115 react under non-participating cover gas 116 within the vessel 110 to produce a uranium carbide product 118, depicted within processing zone 140. While uranium carbide product 118 is depicted within processing zone 140 for clarity, it should be understood that uranium carbide product 118 is produced continuously within vessel 110 and thus may also be located within vessel 110 prior to isolation at processing zone 140.

Accordingly, in some embodiments, when uranium carbide product 118 is produced in vessel 110, it may be transported via coupling 145 to processing zone 140. Non-participating cover gas 118 may accompany uranium carbide product 118 to be subsequently vented and/or recirculated through cover gas vent 142. In some embodiments, a continuous process such as in a flow reactor proceeds by mixing reagents together and feeding the mixed reagents into a reaction chamber (such as a heated tube). The reaction chamber may be configured to provide the appropriate residence time within the reaction zone. After the appropriate residence time, the reaction product mixture may exit the reactor and uranium carbide product 118 would be separated by one or more of hot filtration to remove solid uranium carbide product 118 from the molten mixture; density separation of uranium carbide product 118 from the molten reaction mixture; and/or washing of the reaction mixture with a solvent such as THE, DMF, or DMSO to isolate the uranium carbide product 118 from the chloride salt component.

In some embodiments, such as in a batch process, after a reaction time has elapsed, heating may cease and isolation steps may be taken at processing zone 140 to collect the uranium carbide product 118. For instance, the vessel 110 may be cooled, leading to crystallization and separation of the uranium carbide product 118 from the salt byproducts. During this cooling and crystallization process, the uranium carbide product 118 may be rinsed and filtered from the rinsate reaction mixture.

In some embodiments, the vessel is a zirconia vessel, a nickel vessel, a tungsten vessel, a tantalum vessel, a stainless-steel vessel, or a molybdenum vessel.

In some embodiments, the uranium-containing blend includes a uranium source, a chloride salt, a carbon source incorporated into the uranium-containing blend, and a reductant, wherein the uranium source is a uranium oxide or a uranium halide.

In some embodiments, the heating element is further configured to cool the vessel to a temperature below the melting point of the chloride salt.

In some embodiments, the reaction temperature is between about 200° C. and 900° C.

In some embodiments, the processing zone is a batch processing zone configured to isolate uranium carbide in a batch process.

In some embodiments, the processing zone is a flow processing zone configured to continuously isolate uranium carbide in a flow process.

In some embodiments, the carbon source is solid black carbon.

In some embodiments, the uranium-containing blend comprises a reductant and a chloride salt.

### Processes for Producing Uranium Carbide

In an aspect, the present disclosure provides a method for producing uranium carbide, the method including: heating a vessel containing a blend including a uranium source, a chloride salt, a carbon source, and a reductant under a non-participating cover gas, wherein the vessel is maintained at a reaction temperature and for a reaction time sufficient to produce a molten reaction mixture including the uranium carbide; and isolating the uranium carbide, wherein the uranium source is a uranium oxide or a uranium halide.

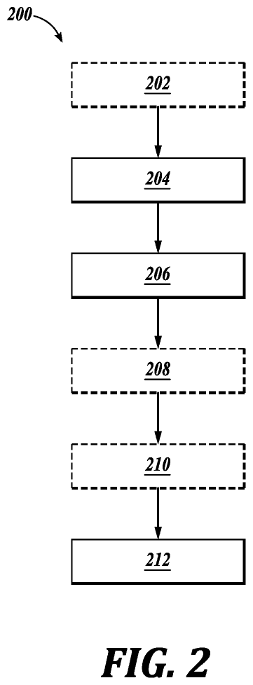

In this regard, FIG. 2 provides a process 200 for producing uranium carbide. Process 200 begins with optional process step 202 combining reagents (i.e., uranium source 112, chloride salt 113, carbon source 114, and reductant 115) under a non-participating cover gas in a vessel (such as vessel 110). Once the reagents and the non-participating cover gas are combined together within a vessel, at process step 204 the vessel is heated. Subsequently, at process step 206 uranium carbide product is provided by reactions between the reagents under the non-participating cover gas.

Once uranium carbide product is produced, optional process step 208 provides for a cooling of the vessel to encourage solidification of chloride salt 113, and optional process step 110 provides for rinsing the cooled mixture to leave behind the uranium carbide product. This together may, in some embodiments, facilitate the subsequent process step 212 of isolating uranium carbide from the reagents.

It should be understood though that in some embodiments, the uranium carbide may be separated according to other approaches as described further herein below and no cooling step 208 or rinsing step 210 is required.

In some embodiments, the uranium oxide is selected from the group consisting of UO₂, UO₃, and UOₓ, where 1.9≤x≤3. In this regard, the uranium oxide may include uranium oxides such as U₃O₈ or U₂O₅, or the uranium oxide may be a non-stoichiometric mixture of uranium oxides.

In some embodiments, the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UI₆, and combinations thereof.

In some embodiments, the uranium halide includes a mixed metal uranium halide.

In some embodiments, the chloride salt is an anhydrous chloride salt. In some embodiments, the chloride salt is LiCl, NaCl, KCl, CaCl₂, or GaCl₃, or the like. In some embodiments, the chloride salt may include one chloride salt species, two chloride salt species, or three or more chloride salt species. In some embodiments, the chloride salt includes a first chloride salt and a second chloride salt having a binary ratio of the first chloride salt and the second chloride salt, wherein the binary ratio is about a eutectic ratio. In some embodiments, the eutectic ratio for a chloride salt comprising LiCl and KCl is about a 60/40 molar ratio. In some embodiments, the eutectic ratio for a chloride salt comprising CaCl₂) and LiCl is about a 35/65 molar ratio. In some embodiments, the eutectic ratio for a chloride salt comprising CaCl₂) and KCl is about a 26/74 molar ratio. In some embodiments, the eutectic ratio for a chloride salt comprising CaCl₂ and LiCl is about a 74/26 molar ratio. In some embodiments, the eutectic ratio for a chloride salt comprising NaCl and KCl is about a 50/50 molar ratio. In some embodiments, a binary ratio of first and second non-oxide salts that is a eutectic ratio may advantageously be used to provide a mixture at a lower melting point than either component alone. This may result in additional cost savings for methods according to the present disclosure because a lower operating temperature may be maintained.

In some embodiments, the reductant is an alkali metal, an alkaline earth metal, an alkali metal hydride, or an alkaline earth metal hydride.

In some embodiments, the reductant is selected from the group consisting of Li, Na, K, Rb, Mg, Ca, Sr, LiH, NaH, KH, RbH, MgH₂, CaH₂, and SrH₂.

In some embodiments, the non-participating cover gas is nitrogen, a noble gas, or CO₂.

In some embodiments, the vessel is a zirconia vessel, a nickel vessel, a tungsten vessel, a tantalum vessel, a stainless-steel vessel, or a molybdenum vessel.

In some embodiments, the vessel is configured to produce uranium carbide in a batch process.

In some embodiments, the vessel is configured to produce uranium carbide in a flow process.

In some embodiments, the reaction temperature is between about 200° C. and 900° C. In some embodiments, the reaction temperature is between about 600° C. and 900° C. However, it should be understood that higher reaction temperatures may be used, for example, to increase the reaction rate, or to take advantage of a chloride salt with a higher melting point. An advantage of the present disclosure is the ability to operate at significantly lower temperatures compared to the state-of-the-art processes. This can result in significant cost savings both in terms of energy costs, as well as allowing the use of equipment that can operate only at lower temperatures. Similarly, lower reaction temperatures are within the scope of the present disclosure, such as where the chloride salt has a melting point of about 400° C., about 300° C., 200° C., or less.

In some embodiments, the reaction time is less than 24 hours, less than 10 hours, less than 8 hours, less than 6 hours, less than 4 hours, less than 2 hours, or less than 1 hour. In some embodiments, the reaction time is determined by the time required to achieve the reaction temperature. In some embodiments, the reaction time is at least 1 minute, at least 10 minutes, at least 30 minutes, or at least 1 hour. In some embodiments, the reaction time is based on both the reaction temperature and the volume of the reaction mixture. In some embodiments, the reaction time is between about 1 hour and about 8 hours.

In some embodiments, the method further includes cooling the molten reaction mixture to a temperature below the melting point of the chloride salt to provide the uranium carbide and a salt byproduct.

In some embodiments, further includes rinsing the cooled molten reaction mixture with a polar aprotic solvent.

In some embodiments, the polar aprotic solvent is tetrahydrofuran (THF), dimethylformamide (DMF), or dimethyl sulfoxide (DMSO). In some embodiments, the polar aprotic solvent is a polar aprotic solvent suitable to solubilize the chloride salt.

In some embodiments, cooling the molten reaction mixture includes cooling at a cooling rate.

In some embodiments, the cooling rate is between about 0.1° C./min to about 10° C./min. Without wishing to be bound by any particular theory, a slower cooling rate may improve the purity and increase the crystal size of the uranium carbide crystals produced by the method. Conversely, a faster cooling rate may increase the surface area of crystalline uranium carbide produced.

In some embodiments, a stoichiometric ratio of the blend is 1 mole uranium oxide:between about 1.2 to about 100 moles chloride salt:between about 1 to about 4 moles carbon source:between about 1 to about 20 moles of reductant.

In some embodiments, isolating the reaction includes hot filtering the reaction mixture, thereby providing the uranium carbide. For example, in hot filtering, uranium carbide may first be synthesized, followed by an additional cycle of heating with the addition of fresh chloride salt. Following this additional heating step, the excess chloride salt may be poured off from the reaction mixture, leaving behind the uranium carbide.

In an aspect, the present disclosure provides a composition including the uranium carbide produced by the methods described herein. In some embodiments, the composition comprises trace chloride contamination from the chloride salt. In some embodiments, the composition comprises trace oxides of the reductant, such as Li₂O when the reductant is LiH.

In some embodiments, a particle size of the uranium carbide produced by any of the methods described herein is about 500 nm to about 10 μm. In some embodiments, larger particle sizes have lower surface area and higher uranium density. In some embodiments, smaller particle sizes may be used for sintering pellets. An advantage of uranium carbide crystals of this size is an increased packing density when rods are formed of the uranium carbide, such as for rods used in nuclear fuel. The reduced surface area resulting from the relatively large crystalline size may result in improved energy extraction and/or reduced corrosion, both important factors in selecting a suitable nuclear fuel. This increased packing density may improve the performance of nuclear fuel generated by uranium carbide produced according to the methods of the present disclosure. In some embodiments, improving the performance of nuclear fuel comprises improving the efficiency of the nuclear fuel, where efficiency is defined as a total time in operation between fuel changes. In some embodiments, efficiency is defined by the total burnup of fissile material per irradiation cycle. In some embodiments, efficiency is defined as increasing thermal conductivity of the fuel, thus increasing the ratio of electrical energy output to nuclear energy released.

In an aspect, the present disclosure provides a method for producing uranium carbide, the method including: heating a zirconia, a tantalum, or a nickel crucible containing a blend including a uranium source, LiCl, a carbon source, and LiH or CaH₂ under argon or nitrogen gas, wherein the zirconia, tantalum, or nickel crucible is maintained at a reaction temperature of between about 600° C. and about 900° C. for 8 hours thereby providing uranium carbide; and isolating the uranium carbide, wherein the uranium source is a uranium oxide or a uranium halide.

### Definitions

As used herein, “about” in reference to a numerical value refers to the range of values somewhat less or greater than the stated value, as understood by one of skill in the art. In this manner, the term “about” could mean a value ranging from plus or minus a percentage (±5%) of the stated value. Furthermore, since all numbers, values, and expressions referring to quantities used herein are subject to the various uncertainties of measurement encountered in the art, then unless otherwise indicated, all presented values may be understood as modified by the various uncertainties of the respective measurements encountered in the art.

As used herein, “salt” refers to a combination of one or more of a positively charged cation and one or more of a negatively charged anion having any ionic chemical formula.

As used herein, “chloride salt” refers to an ionic composition including at least one cation and at least one chloride anion.

As used herein, “black carbon” refers to an amorphous allotrope of elemental carbon.

As used herein, “reductant” refers to metal or metal hydride species capable of acting as a reducing agent for uranium ions during the method steps.

As used herein, a “non-participating cover gas” refers to a gas environment contacting the reaction mixture that is substantially free of chemically reactive gases (i.e., inert) including oxygen, water, methane, ammonia, ozone, nitrous oxides, etc.

As used herein, “vessel” refers to any container suitable for containing the various reagents and capable of being held at the temperatures required for the reaction to proceed, such as a crucible, or a continuous flow reactor.

As used herein, “molten reaction mixture” refers to the solution, colloidal mixture, suspension, or other mixture, formed by the combination of uranium precursor material, a chloride salt, a carbon source, and a reductant, and that may also contain the products generated by the reaction thereof. In a non-limiting example, the uranium precursor material may be uranium oxide.

As used herein, a “blend” refers to mixture or combination of two or more solid compositions. Such mixtures may be heterogeneous or homogeneous with respect to their compositions. The solid compositions may be powders, crystals, flakes, ingots, or any other solid form in which the relevant composition may be formed.

As used herein, a “mixed metal uranium halide” refers to an alkali-salt-soluble ternary, quaternary, quinary, or higher mixed metal uranium halide, such as K₂UCl₆, NaRbUCl₆, etc. A “mixed metal uranium halide” thus represents a salt-soluble species (i.e., one that may be dissolved in a molten salt).

As used herein, “uranium carbide” refers generally to uranium monocarbide, uranium dicarbide, and compositions comprising a combination and/or mixture thereof.

As used herein, “uranium containing blend” refers to a blend wherein one or more components of the blend contain uranium atoms.

### EXAMPLES

For clarity and brevity, a procedure for generating uranium carbide is described at a batch production laboratory scale. However, it should be understood that a person of ordinary skill in the art would be able to adapt the experimental procedures described herein for other purposes, including a continuous production laboratory scale synthesis, an industrial batch production industrial scale, a continuous production industrial scale, and other variations.

### Example 1: Molten Salt Synthesis of Uranium Monocarbide from UO₂, UO₃, UCl₄, and UBr₅

A molten salt synthesis (MSS) method for producing uranium monocarbide (UC) is demonstrated herein at 900° C. using LiH as reductant and LiCl as the reaction medium. The method is demonstrated for UO₂, UO₃, UCl₄, and UBr₅ precursors and achieves complete conversion of precursor uranium sources to UC within one hour. Products are isolated by dissolving LiCl in polar aprotic solvents (e.g., DMF or THF). Representative reactions for oxide- and halide-derived pathways are given in Equations 1 and 2 respectively.

UOₙ+C+2nLiH→UC+nLi₂O+nH₂ Eq. 1:

UXₙ+C+nLiH→UC+nLiX+(n/2)H₂ Eq. 2:

### Methods

Uranium oxide and halides precursors (referred to generally as UOₙ or UXₙ, or as a “uranium source”, and used individually or in combination), carbon, LiH, and LiCl were combined in a 1:2:20:25 molar ratio (uranium as the limiting reagent). For instance, in a representative embodiment, a lab-scale batch synthesis contained 135.0 mg (0.5 mmol) UO₂, 12.0 mg (1 mmol) carbon, 79.5 mg (10 mmol) LiH, and 529.9 mg (12.5 mmol) LiCl. Powders were wet mixed with THE in a mortar and pestle, dried under reduced pressure, loaded into a ~5 mL tantalum crucible, and heated at 10° C. min⁻¹ to 900° C. After a 1 h dwell, the furnace was cooled at 10° C. min⁻¹ to room temperature. Products were collected by washing with DMF to dissolve LiCl, then rinsed with THE and dried under reduced pressure.

### Results

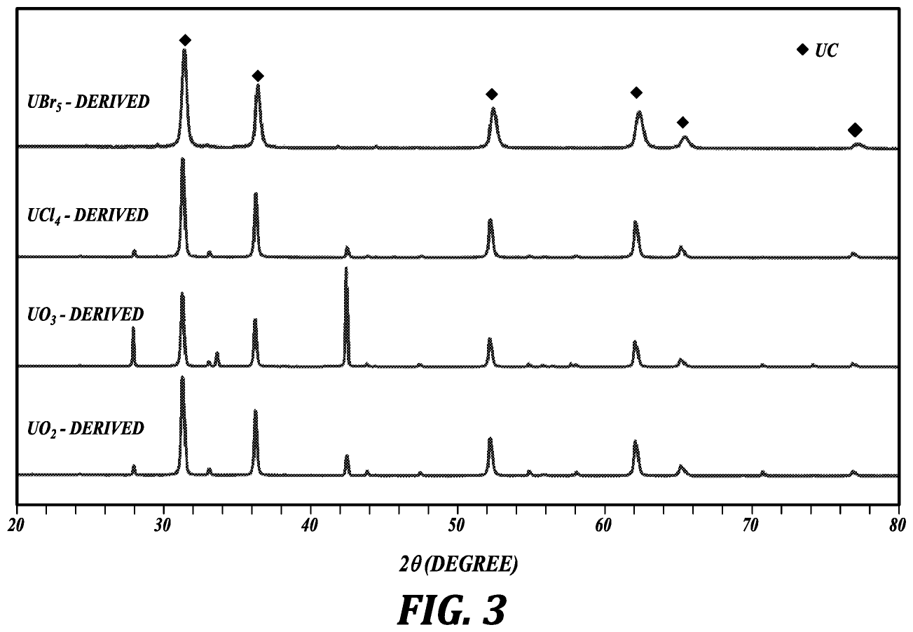

Powder x-ray diffraction (XRD) patterns of products obtained from reactions conducted with UO₂, UO₃, UCl₄, and UBr₅ are shown in FIG. 3. In all cases UC presents as the predominant phase, with characteristic 111, 200, 220, 311, 222, and 400 reflections centered at 2θ values of 31.3°, 36.3°, 52.2°, 62.2°, 65.3°, and 77.0° respectively. Minor secondary features observed in the products of UO₂-, UO₃-, and UCl₄-derived materials are observed and attributed to the formation of metastable Li—O—Cl species. This is evidenced by complete removal of this phase upon brief water washing. Additionally, energy-dispersive x-ray spectroscopy (EDS) elemental analysis reveals a second phase segregated product containing elevated Cl and O (Li is not detectable by EDS).

Refined a-axis lattice parameters of the cubic UC structure and corresponding empirical determination of UC₁₋ₓOₓ stoichiometry derived from literature data are summarized in Table 1.

TABLE 1
Lattice parameters determined from XRD, and corresponding
stoichiometry interpolated from literature data.

| Starting | Latice parameter a (Å) | x in UC₍ₓ₋₁₎Oₓ determined |
|---|---|---|
| Material | (Standard Error) | from XRD (Standard Error) |
| UO₂ | 4.96194(10) | 0.006(12) |
| UO₃ | 4.95919(7) | 0.088(8) |
| UCl₄ | 4.96163(5) | 0.015(11) |
| UBr₅ | 4.94833(6) | 0.402(16) |

UC adopts the rock-salt (NaCl-type) structure; oxygen incorporation contracts the a-axis as oxygen content increases. Using historical data of the uranium-plutonium-oxygen system, the a-axis contraction of the cubic UC crystal system has been corelated to x in UC₁₋ₓOₓ.

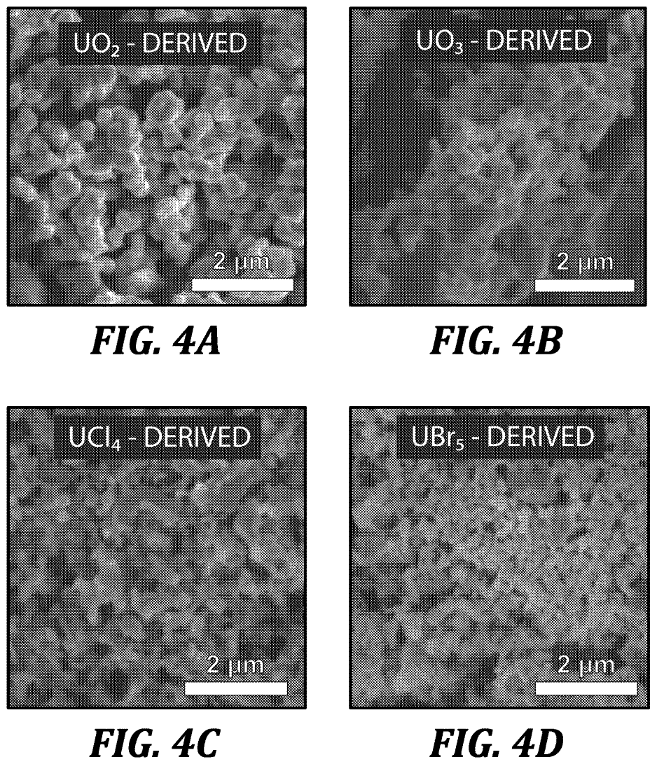

A scanning electron microscopy (SEM) image of UO₂-, UO₃-, UCl₄-, and UBr₅-derived UC are shown in FIGS. 4A-4D. UC forms small, faceted particles with particle size dependent on the use of UOₙ or UXₙ starting materials. Oxide-derived UC forms larger particles (300-500 nm), consistent with surface-mediated reactions and partial oxide dissolution, leading to slower crystallization kinetics; on the other hand, halide-derived UC forms smaller particles (100-200 nm), consistent with increased precursor solubility in the LiH—LiCl melt, promoting homogeneous nucleation and rapid precipitation of UC out of the melt.

Elemental analysis by EDS of UO₂-, UO₃-, UCl₄-, and UBr₅-derived UC are shown in Table 2. Note that elevated oxygen levels are attributed to a combination of factors including environmental contamination, remnant Li₂O, and the formation of solid solutions of UO in the UC lattice.

TABLE 2
EDS elemental analysis of MSS derived UC.

| Starting | At. % U | At. % C | At. % O |
|---|---|---|---|
| Material | (Standard Error) | (Standard Error) | (Standard Error) |
| UO₂ | 40.8(2.0) | 48.7(1.8) | 10.6(0.1) |
| UO₃ | 39.6(6.5) | 45.1(6.7) | 15.3(5.0) |
| UCl₄ | 41.4(4.0) | 45.2(2.1) | 13.4(3.6) |
| UBr₅ | 42.3(2.7) | 41.9(3.9) | 15.8(3.6) |

This example illustrates that a molten salt synthesis route to UC at 900° C. affords phase-pure product within 1 h from a wide range of uranium precursors. The process suppresses formation of higher order carbides (U₂C₃ and UC₂) observed in high temperature carbothermal routes and improves stoichiometric control while reducing safety and volatility concerns compared to traditional carbothermal methods. Morphology and oxygen incorporation trends reflect precursor identity and solubility within the molten salt environment, with UOₙ precursors leading to particles in the range of 300-500 nm, and UXₙ precursors leading to particle sizes in the range of 100-200 nm, originating from increased solubility of the halide precursor resulting in rapid crystallization upon reaction.

### Example 2: Molten Salt Synthesis of Uranium Carbide from Uranium Oxides

### Methods

Within an argon or nitrogen filled glovebox, anhydrous chloride salt, UO₂ or UO₃, C, and a reductant were combined in stochiometric ratios of 1 mole UO₂ or UO₃, 1 mole C, 4 or 6 moles CaH₂ and 6 moles salt. The idealized reaction using CaH₂ as a reductant is seen in Equation 3. The reaction mixture was loaded into a zirconia, tantalum, or nickel crucible and placed into the center of a chamber furnace within the glovebox and heated to the reaction temperature of 600-900° C. where it was held for 8 hours.

The reaction was allowed to cool to below the melting point of the chosen salt system at a rate of 1° C. min⁻¹. At this point the reaction mixture was washed with tetrahydrofuran (THF) to remove salt, leaving behind a mixture of UC and the byproduct calcium oxide (CaO) and calcium dihydroxide (Ca(OH)₂).

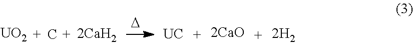

### Material Characterization

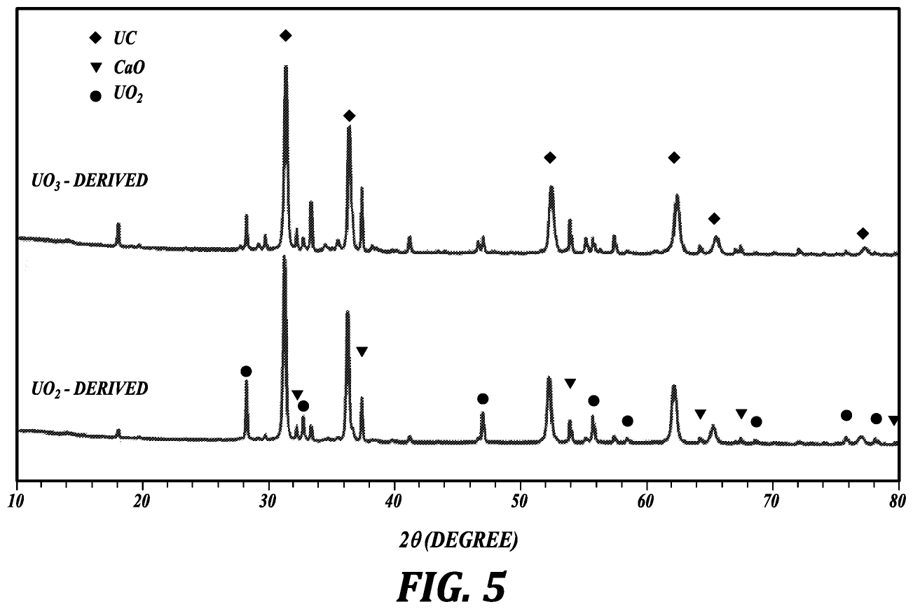

FIG. 5 shows powder XRD patterns of processed UC synthesized using UO₂ or UO₃ as starting materials. XRD patterns of UC exhibit characteristic 111, 200, 220, and 311 reflections centered at 31.21°, 36.20°, 52.12°, and 62.02° respectively. CaO is found as a phase separated byproduct of the reaction according to Equation 3. Unreacted UO₂ is found as a minor phase. Quantitative phase distribution of products synthesized from UO₂ and UO₃ can be seen in Table 3.

TABLE 3
Quantitative phase distribution of UC synthesis
products of reactions conducted with UO₂ and UO₃.

| Uranium | | | | | |
|---|---|---|---|---|---|
| oxide | UC | CaO | Ca(OH)₂ | UO₃ | UO₂ |
| Reagent | (Wt. %) | (Wt. %) | (Wt. %) | (Wt. %) | (Wt. %) |
| UO₂ | 30.4 ± 0.9 | 19.5 ± 0.9 | 43.9 ± 0.9 | 0 ± 0 | 6.3 ± 0.9 |
| UO₃ | 54.4 ± 1.7 | 37.3 ± 1.7 | 0 ± 0 | 2.8 ± 1.7 | 5.5 ± 1.7 |

### Analysis

Uranium monocarbide has been synthesized using a novel molten salt synthesis method using various oxides of uranium as the reaction feedstock. This method allows for the formation of uranium monocarbide at temperatures and times well below what is currently used in industrial applications to generate equivalent material. State of the art industrial scale uranium carbide is currently synthesized through carbothermal reduction at temperatures >1500° C. for multiple days under vacuum. This process is inefficient due to prolonged reaction times at high temperatures, and due to loss of carbon from the system, limiting isotope enrichment when desirable.

The molten salt synthesis methods of the present disclosure allow for the synthesis of uranium monocarbide in a matter of hours at temperatures well below 1000° with improved atom efficiency compared to state-of-the-art methods. The methods of the present disclosure reduce synthetic cost and improves scalability.

### Example 3: Molten Salt Synthesis of Uranium Carbide from Uranium Halides

### Methods

Within an inert atmosphere glovebox, anhydrous chloride salt, UBr₅, C, and a reductant were combined in stochiometric ratios of 1 mole UBr₅, 2 mole C, 10 mole LiH, and 25 mole salt. The idealized reaction using LiH as a reductant is seen in Equation 4. The reaction mixture was loaded into a tantalum crucible and placed into the center of a furnace within the glovebox and heated to the reaction temperature of 600-900° C. where it was held at temperature for 8 hours, though other durations can apply.

The reaction was allowed to cool to below the melting point of the chosen salt system. At this point the reaction mixture was washed with tetrahydrofuran (THF) to remove salt, leaving behind a mixture of UC and UC₂ with minor uranium oxide contaminant starting material.

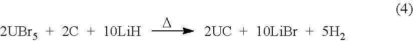

### Material Characterization:

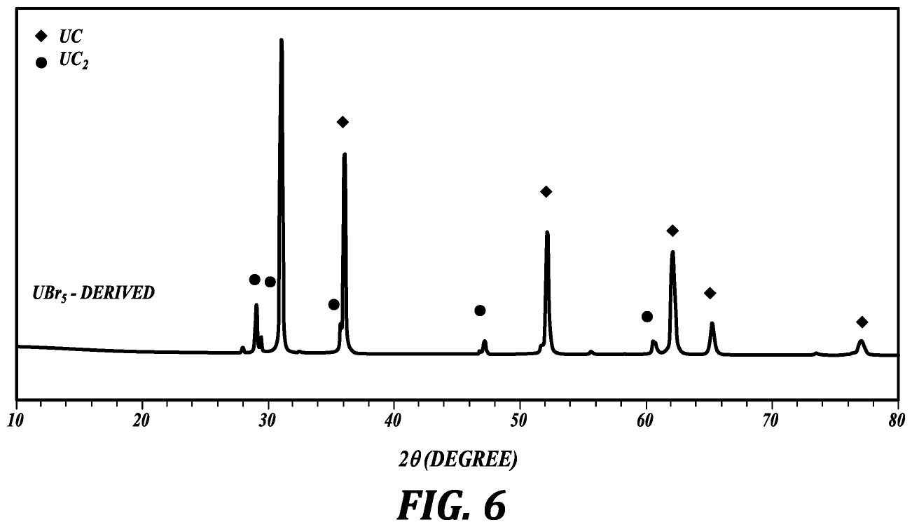

FIG. 6 shows powder XRD patterns of processed UC/UC₂ synthesized using UBr₅ as starting materials. XRD patterns exhibit characteristic 111, 200, 220, and 311 reflections of UC centered at 31.21°, 36.20°, 52.12°, and 62.02° respectively. UC₂ is also observed through the characteristic 101, and 002 reflections centered at 29.5°, and 29.9° respectively. Trace quantities of unreacted contaminant UO₂ are found as a minor phase. Quantitative phase distribution of products synthesized from UBr₅ can be seen in Table 4.

TABLE 4
Quantitative phase distribution of
UBr₅ derived UC under molten salt conditions.

| | UC | UC₂ | UO₂ |
|---|---|---|---|
| Uranium Halide Reagent | (Wt. %) | (Wt. %) | (Wt. %) |
| UBr₅ | 86.2 ± 0.1 | 12.8 ± 0.1 | 1.0 ± 0.1 |

### Analysis:

Uranium monocarbide mixed with uranium dicarbide has been synthesized using a novel molten salt synthesis method using Uranium halide starting material. This method allows for the formation of uranium carbide at temperatures and times well below what is currently used in industrial applications to generate equivalent material. State of the art industrial scale uranium carbide is currently synthesized through carbothermal reduction at temperatures >1500° C. for multiple days under vacuum. The state-of-the-art process is inefficient due to prolonged reaction times at high temperatures, and loss of carbon from the system, limiting isotope enrichment when desirable. The disclosed MSS method allows for the synthesis of uranium carbide in a matter of hours at temperatures well below 1000° with improved atom efficiency compared to state-of-the-art methods. The disclosed MSS method reduces synthetic cost and improves scalability. The use of uranium halide starting material is advantageous as isotope enrichment also relies on uranium halides. Using out methods, the output from enrichment can be directly used for the synthesis of UC fuel forms, as opposed to relying on an intermediate step to convert back to the oxide prior to synthesis. This method streamlines the fuel fabrication process by reducing intermediate steps while at the same time produces high quality uranium carbide material with lower energy inputs compared to traditional methods.

The detailed description set forth above in connection with the appended drawings, where like numerals reference like elements, are intended as a description of various embodiments of the present disclosure and are not intended to represent the only embodiments. Each embodiment described in this disclosure is provided as a representative example or illustration and should not be construed as preferred or advantageous over other embodiments. The representative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification. That is, the present disclosure includes embodiments that combine features from different embodiments.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

In the detailed description herein, references to “one embodiment,” “an embodiment,” “an example embodiment,” “some embodiments,” “one or more embodiments,” etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure May employ any combination of features described herein. All such combinations or sub-combinations of features are within the scope of the present disclosure.

In view of the limitations of the processing techniques available in the field, the terms “approximately”, “substantially”, and “about” reflect a certain inability (or uncertainty) to precisely control the exact dimensions of certain features and measurements described herein. Depending on the level of precision that can be achieved using the commercially available processing and measurement tools available at the time, the terms “approximately”, “substantially”, and “about” may be used to mean within +5% of a target value for some features. The terms “approximately”, “substantially”, and “about” may include the target value. Furthermore, since all numbers, values, and expressions referring to quantities used herein are subject to the various uncertainties of measurement encountered in the art, then unless otherwise indicated, all presented values may be understood as modified by the various uncertainties of the respective measurements encountered in the art.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

The present application may also reference quantities and numbers. Unless specifically stated, such quantities and numbers are not to be considered restrictive, but exemplary of the possible quantities or numbers associated with the present application. The term “plurality” is meant to be any number that is more than one, for example, two, three, four, five, etc. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

### NON-LIMITING EMBODIMENTS

While general features of the disclosure are described and shown and particular features of the disclosure are set forth in the claims, the following non-limiting embodiments relate to features, and combinations of features, that are explicitly envisioned as being part of the disclosure. The following non-limiting embodiments contain elements that are modular and can be combined with each other in any number, order, or combination to form a new non-limiting embodiment, which can itself be further combined with other non-limiting embodiments.

Embodiment 1. A method for producing uranium carbide, the method including: heating a vessel containing a blend including a uranium source, a chloride salt, a carbon source, and a reductant under a non-participating cover gas, wherein the vessel is maintained at a reaction temperature and for a reaction time sufficient to produce a molten reaction mixture including the uranium carbide; and isolating the uranium carbide, wherein the uranium source is a uranium oxide or a uranium halide.

Embodiment 2. The method of Embodiment 1 or any other Embodiment, wherein the uranium oxide is selected from the group consisting of UO₂, UO₃, and UOₓ, where 1.9≤x≤3.

Embodiment 3. The method of any of Embodiments 1-2 or any other Embodiment, wherein the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UI₆, and combinations thereof.

Embodiment 4. The method of any of Embodiments 1-3 or any other Embodiment, wherein the uranium halide includes a mixed metal uranium halide.

Embodiment 5. The method of any of Embodiments 1-4 or any other Embodiment, wherein the chloride salt is LiCl, NaCl, KCl, CaCl₂, or GaCl₃.

Embodiment 6. The method of any of Embodiments 1-5 or any other Embodiment, wherein the chloride salt includes a first chloride salt and a second chloride salt having a binary ratio of the first chloride salt and the second chloride salt, wherein the binary ratio is about a eutectic ratio.

Embodiment 7. The method of any of Embodiments 1-6 or any other Embodiment, wherein the reductant is an alkali metal, an alkaline earth metal, an alkali metal hydride, or an alkaline earth metal hydride.

Embodiment 8. The method of any of Embodiments 1-7 or any other Embodiment, wherein the reductant is selected from the group consisting of Li, Na, K, Rb, Mg, Ca, Sr, LiH, NaH, KH, RbH, MgH₂, CaH₂, and SrH₂.

Embodiment 9. The method of any of Embodiments 1-8 or any other Embodiment, wherein the non-participating cover gas is nitrogen, a noble gas, or CO₂.

Embodiment 10. The method of any of Embodiments 1-9 or any other Embodiment, wherein the vessel is a zirconia vessel, a nickel vessel, a tungsten vessel, a tantalum vessel, a stainless-steel vessel, or a molybdenum vessel.

Embodiment 11. The method of any of Embodiments 1-10 or any other Embodiment, wherein the vessel is configured to produce uranium carbide in a batch process.

Embodiment 12. The method of any of Embodiments 1-11 or any other Embodiment, wherein the vessel is configured to produce uranium carbide in a flow process.

Embodiment 13. The method of any of Embodiments 1-12 or any other Embodiment, wherein the reaction temperature is between about 200° C. and 900° C.

Embodiment 14. The method of any of Embodiments 1-13 or any other Embodiment, wherein the reaction temperature is between about 600° C. and 900° C.

Embodiment 15. The method of any of Embodiments 1-14 or any other Embodiment, wherein the reaction time is less than 24 hours, less than 10 hours, less than 8 hours, less than 6 hours, less than 4 hours, less than 2 hours, or less than 1 hour.

Embodiment 16. The method of any of Embodiments 1-15 or any other Embodiment, further including cooling the molten reaction mixture to a temperature below the melting point of the chloride salt to provide the uranium carbide and a salt byproduct.

Embodiment 17. The method of any of Embodiments 1-16 or any other Embodiment, further including rinsing the cooled molten reaction mixture with a polar aprotic solvent.

Embodiment 18. The method of any of Embodiments 1-17 or any other Embodiment, wherein the polar aprotic solvent is tetrahydrofuran (THF), dimethylformamide (DMF), or dimethyl sulfoxide (DMSO).

Embodiment 19. The method of any of Embodiments 1-18 or any other Embodiment, wherein cooling the molten reaction mixture includes cooling at a cooling rate.

Embodiment 20. The method of any of Embodiments 1-19 or any other Embodiment, wherein the cooling rate is between about 0.1° C./min to about 10° C./min.

Embodiment 21. The method of any of Embodiments 1-20 or any other Embodiment, wherein a stoichiometric ratio of the blend is 1 mole uranium oxide:between about 1.2 to about 100 moles chloride salt:between about 1 to about 4 moles carbon source:between about 1 to about 20 moles of reductant.

Embodiment 22. The method of any of Embodiments 1-21 or any other Embodiment, wherein isolating the reaction includes hot filtering the reaction mixture, thereby providing the uranium carbide.

Embodiment 23. A composition including the uranium carbide produced by the method of any of Embodiments 1-22 or any other Embodiment.

Embodiment 24. A method for producing uranium carbide, the method including: heating a zirconia, a tantalum, or a nickel crucible containing a blend including a uranium source, LiCl, a carbon source, and LiH or CaH₂ under argon or nitrogen gas, wherein the zirconia, tantalum, or nickel crucible is maintained at a reaction temperature of between about 600° C. and about 900° C. for 8 hours thereby providing uranium carbide; and isolating the uranium carbide, wherein the uranium source is a uranium oxide or a uranium halide.

Embodiment 25. A system for producing uranium carbide, the system including: a vessel including a uranium-containing blend for forming a uranium carbide and a non-participating cover gas; a heating element operatively coupled to the vessel, the heating element being configured to maintain the vessel at a reaction temperature sufficient to produce a reaction mixture of the molten uranium-containing blend; and a processing zone fluidly coupled to the vessel, the processing zone being configured to isolate the uranium carbide produced by the reaction of the uranium-containing blend.

Embodiment 26. The system of Embodiment 25 or any other Embodiment, wherein the vessel is a zirconia vessel, a nickel vessel, a tungsten vessel, a tantalum vessel, a stainless-steel vessel, or a molybdenum vessel.

Embodiment 27. The system of Embodiment 25-26 or any other Embodiment, wherein the uranium-containing blend includes a uranium source, a chloride salt, a carbon source incorporated into the uranium-containing blend, and a reductant.

Embodiment 28. The system of Embodiment 25-27 or any other Embodiment, wherein the heating element is further configured to cool the vessel to a temperature below the melting point of the chloride salt.

Embodiment 29. The system of Embodiment 25-28 or any other Embodiment, wherein the uranium source is a uranium oxide or a uranium halide.

Embodiment 30. The system of Embodiment 25-29 or any other Embodiment, wherein the reaction temperature is between about 200° C. and 900° C.

Embodiment 31. The system of Embodiment 25-30 or any other Embodiment, wherein the processing zone is a batch processing zone configured to isolate uranium carbide in a batch process.

Embodiment 32. The system of Embodiment 25-31 or any other Embodiment, wherein the processing zone is a flow processing zone configured to continuously isolate uranium carbide in a flow process.

Embodiment 33. The system of Embodiments 25-32 or any other Embodiment, wherein the carbon source is solid black carbon.

Embodiment 34. The system of Embodiments 25-33 or any other Embodiment, wherein the uranium-containing blend comprises a reductant and a chloride salt.

While illustrative embodiments have been illustrated and described, it will be appreciated that various changes can be made therein without departing from the spirit and scope of the invention.

What is claimed is:

1. A method for producing uranium carbide, the method comprising:
heating a vessel containing a blend comprising a uranium source, a chloride salt, a carbon source, and a reductant under a non-participating cover gas, wherein the vessel is maintained at a reaction temperature and for a reaction time sufficient to produce a molten reaction mixture comprising the uranium carbide; and
isolating the uranium carbide,
wherein the uranium source is a uranium oxide or a uranium halide.

2. The method of claim 1, wherein the uranium oxide is selected from the group consisting of UO₂, UO₃, and UOₓ, where 1.9≤x≤3.

3. The method of claim 1, wherein the uranium halide is selected from the group consisting of UF₃, UCl₃, UBr₃, UI₃, UF₄, UCl₄, UBr₄, UI₄, UF₅, UCl₅, UBr₅, UI₅, UF₆, UCl₆, UBr₆, UI₆, and combinations thereof.

4. The method of claim 1, wherein the uranium halide comprises a mixed metal uranium halide.

5. The method of claim 1, wherein the chloride salt is LiCl, NaCl, KCl, CaCl₂, or GaCl₃.

6. The method of claim 1, wherein the chloride salt comprises a first chloride salt and a second chloride salt having a binary ratio of the first chloride salt and the second chloride salt, wherein the binary ratio is about a eutectic ratio.

7. The method of claim 1, wherein the reductant is an alkali metal, an alkaline earth metal, an alkali metal hydride, or an alkaline earth metal hydride.

8. The method of claim 7, wherein the reductant is selected from the group consisting of Li, Na, K, Rb, Mg, Ca, Sr, LiH, NaH, KH, RbH, MgH₂, CaH₂, and SrH₂.

9. The method of claim 1, wherein the non-participating cover gas is nitrogen, a noble gas, or CO₂.

10. The method of claim 1, wherein the vessel is a zirconia vessel, a nickel vessel, a tungsten vessel, a tantalum vessel, a stainless-steel vessel, or a molybdenum vessel.

11. The method of claim 1, wherein the reaction temperature is between about 200° C. and 900° C.

12. The method of claim 1, wherein the reaction time is less than 24 hours.

13. The method of claim 1, further comprising cooling the molten reaction mixture to a temperature below the melting point of the chloride salt to provide the uranium carbide and a salt byproduct.

14. The method of claim 1, wherein a stoichiometric ratio of the blend is 1 mole uranium oxide:between about 1.2 to about 100 moles chloride salt:between about 1 to about 4 moles carbon source:between about 1 to about 20 moles of reductant.

15. A composition comprising the uranium carbide produced by the method of claim 1.

16. A system for producing uranium carbide, the system comprising:
a vessel comprising a uranium-containing blend for forming a uranium carbide and a non-participating cover gas;
a heating element operatively coupled to the vessel, the heating element being configured to maintain the vessel at a reaction temperature sufficient to produce a reaction mixture of the molten uranium-containing blend; and
a processing zone fluidly coupled to the vessel, the processing zone being configured to isolate the uranium carbide produced by the reaction of the uranium-containing blend.

17. The system of claim 16, wherein the vessel is a zirconia vessel, a nickel vessel, a tungsten vessel, a tantalum vessel, a stainless-steel vessel, or a molybdenum vessel.

18. The system of claim 16, wherein the uranium-containing blend comprises a uranium source, a chloride salt, a carbon source incorporated into the uranium-containing blend, and a reductant.

19. The system of claim 18, wherein the heating element is further configured to cool the vessel to a temperature below the melting point of the chloride salt.

20. The system of claim 16, wherein the reaction temperature is between about 200° C. and 900° C.
